(19) United States
(12) Patent Application Publication
(10) Pub. No.: US 2012/0007298 A1
(43) Pub. Date: Jan. 12, 2012

(54) ADJUSTABLE BICYCLE WORKSTAND

(76) Inventor: Adrian Daniel PROIETTI, The Gap (AU)

(21) Appl. No.: 13/177,843

(22) Filed: Jul. 7, 2011

(30) Foreign Application Priority Data
Jul. 9, 2010 (AU) 2010903051

(51) Int. Cl. B25H 1/16; B25H 1/00

(52) U.S. Cl. 269/59; 269/58; 269/61

(57) ABSTRACT

An adjustable bicycle workstand is disclosed. The bicycle workstand may include a height adjustable post having at least a first and second tubular member in telescopic arrangement. The second tubular member may be insertable into the first tubular member. The first tubular member may have a ground engaging portion or support base. The workstand may include an internal mechanism for gradual extension and retraction of the second tubular member from the first tubular member. The workstand may include an attachment means for mounting a bicycle associated with the second tubular member. The workstand may be configured for safely raising and lowering a bicycle attached to the stand. Thus, the bicycle workstand may safely and securely support a bicycle for assembly, maintenance and/or repair purposes.

### CROSS-REFERENCE TO RELATED APPLICATIONS

This application claims priority to and the benefit of Australian Application No. 2010903051, filed on Jul. 9, 2010, the entire contents of which are hereby incorporated by reference.

### BACKGROUND

1. Field of the Disclosure

This invention relates to a bicycle repair equipment and apparatus. More particularly, it relates to a bicycle workstand with height adjustability by means of a telescopic mechanism.

2. Description of the Related Art

Bicycle workstands are often required during assembly, maintenance and repair of bicycles. Current bicycle workstands generally consist of a female lower tube attached to a base plate or portable legs and a male upper tube with attached clamping head. The quick release mounted at the intersection of the tubes controls telescopic adjustment and rotation. The height of such workstands often requires repeated manual adjusting in order for the user to service all areas of the bicycle. The continued adjustment of such prior art workstands is an inefficient, manual process that can lead to workplace fatigue and/or injury.

Prior art workstands are only safely adjustable once the bicycle is removed from the stand. Consequently, one must either repeatedly remove the bicycle to adjust the stand height, or repetitively lift and lower the bike in the stand whilst operating the quick release mechanism for final position. Both operations demand repetitive lifting and lowering which can eventually result in fatigue and/or injury. Furthermore, because it may be impractical to repeatedly remove or lift the bike from a prior art workstand, users may continue working at the same height for the duration of the assembly, maintenance and/or repair procedures. This practice may again lead to injury or fatigue due to repetitive bending and extension in order to service all areas of the bicycle.

It is the object of the present invention to seek to ameliorate some or all of the aforementioned disadvantages of the prior art by providing a novel, truly practical and safe, adjustable bicycle workstand.

### SUMMARY OF CERTAIN INVENTIVE ASPECTS

In one aspect, an adjustable bicycle workstand is provided, which can safely and securely support a bicycle for assembly, maintenance and repair purposes.

In another aspect, an adjustable bicycle workstand includes, for example, a height adjustable post having at least a first member having a ground engaging portion or support base, and a second tubular member, an internally housed mechanism for extension and retraction of the second tubular member from the first tubular member, and an attachment means for mounting a bicycle on the second tubular member such that the bicycle may be raised and lowered between a first position and a second position whilst remaining attached to the second tubular member.

In some embodiments, the second tubular member is insertable into the first tubular member in a telescopic arrangement. In some embodiments, the attachment means is rotatably connected to the second tubular member and configured to permit 360 degree rotation of the bicycle. In some embodiments, the workstand is height adjustable using a mechanical winding means. In some embodiments, the attachment means is rotatably connected to the second tubular member and configured to permit 360 degree rotation of the bicycle. In some embodiments, the mechanical winding means is an internally housed rack and pinion arrangement configured to extend and retract the second tubular member from the first tubular member. In some embodiments, an the attachment means is rotatably connected to the second tubular member and configured to permit 360 degree rotation of the bicycle. In some embodiments, the bicycle workstand further includes, for example, a quick release lock mechanism configured to lock the first and second tubular members together and prevent rotation of the bicycle attached to the second tubular member. In some embodiments, the attachment means is a clamp configured to grasp a bicycle frame. In some embodiments, the attachment means is selected from the group consisting of a fastener, tie, rope, velcro, hook, male-female attachment, screw, and lock. In some embodiments, the bicycle workstand further includes, for example, an electric motor drive system configured to adjust the height of the height adjustable post.

In another aspect, a method of using a bicycle workstand includes, for example, safely and securely supporting a bicycle during at least one of assembly, maintenance and repair.

In another aspect, an adjustable bicycle workstand includes, for example, a height adjustable post having at least a first member having a ground engaging portion or support base, and a second tubular member, an internally housed mechanism for gradual extension and retraction of the second tubular member from the first tubular member, and an attachment means for mounting a bicycle with the second tubular member such that the bicycle may be safely raised and lowered whilst remaining attached to the stand.

In some embodiments, the second tubular member is insertable into the first tubular member in a telescopic arrangement. In some embodiments, the workstand is height adjustable using a mechanical winding mechanism such as an internally housed rack and pinion arrangement to extend and retract the second tubular member from the first tubular member. In some embodiments, the bicycle attachment means is rotatably connected to the second tubular member to permit 360 degree rotation of a bicycle. In some embodiments, a quick release lock mechanism is provided, which is configured to lock the first and second tubular members together to prevent rotation of the bicycle when on the stand. In some embodiments, the quick release locking mechanism may be a split section on the top of the first tubular member which has an outer thread and a slightly tapered inner surface. In some embodiments, a large hand operated nut engaging the outer thread squeezes the split section together thereby gripping the second tubular member as the nut is hand tightened. In some embodiments, the bicycle workstand attachment means is a clamping head that includes, for example, clamps adapted to hold a bicycle frame. In some embodiments, the mechanical winding mechanism can be replaced by an electric motor drive system.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of the Preferred Embodiments” one will understand how illustrated features serve to explain certain principles of the present disclosure.

FIG. 1 illustrates one embodiment having a mechanical winding mechanism.

FIG. 2 illustrates a detailed view of a quick release locking mechanism.

### DETAILED DESCRIPTION OF THE PREFERRED EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. Since the disclosure may be modified in various ways and have various embodiments, the disclosure will be described in detail with reference to the drawings. However, it should be understood that the disclosure is not limited to a specific embodiment but includes all changes and equivalent arrangements and substitutions included in the spirit and scope of the disclosure. In the following description, if the detailed description of the already known structure and operation may confuse the subject matter of the present invention, the detailed description thereof will be omitted.

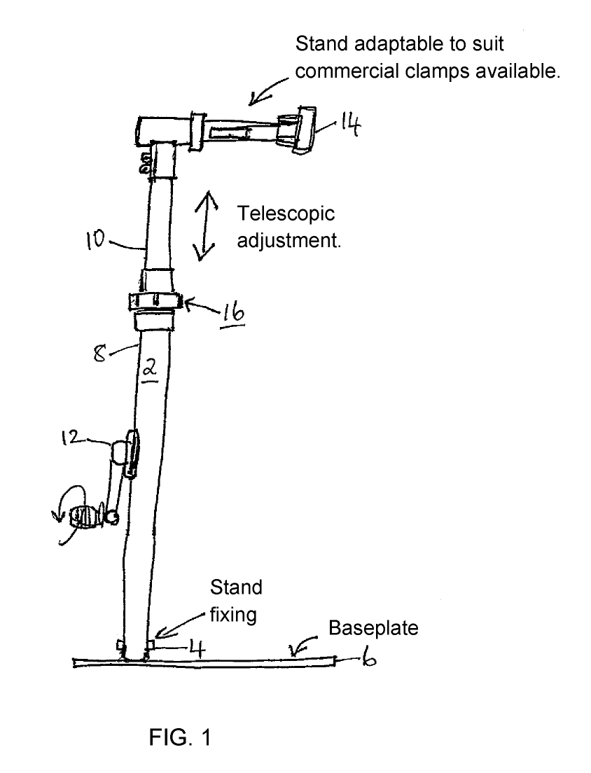

Referring now to the accompanying drawings and initially FIG. 1, there is shown a workstand for a bicycle having a vertical tubular post (2) securely bolted to a post fitting (4) attached to a support base plate (6) configured for supporting the assembly in a substantially upright position. The height adjustable post may include a first (8) and second tubular member (10) in telescopic arrangement. In this example, the workstand has a mechanical winding mechanism (12) configured to operate in an internally housed rack and pinion arrangement (not shown) for gradual extension and retraction of the second tubular member (10) from the first tubular member (8).

A bicycle (not shown) may be attached to the workstand by means of a clamping head (14). Alternative for attaching the bicycle to the workstand may include, for example, a fastener, tie, rope, velcro, hook, male-female attachment, screw, or lock, or some combination thereof. The bicycle may be securely fixed at the desired orientation, for example, by a quick-release locking mechanism (16) formed or positioned at the intersection of the first and second tubular members. The quick-release locking mechanism (16) may be configured to prevent rotation of the bicycle when in a locked position.

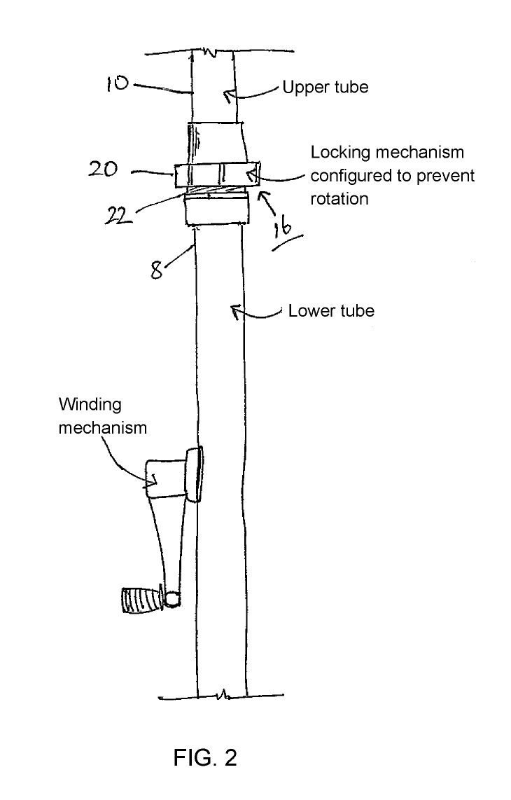

Referring now to FIG. 2, there is shown an illustration of the quick-release locking mechanism (16) of FIG. 1. The quick-release locking mechanism (16) includes a large or knurled nut (20) configured to screw onto a threaded portion (22). As illustrated in FIG. 2, the threaded position (22) is formed at the top of the first tubular member (8). The first tubular member may be split and has a slightly tapered inner surface such that tightening the nut by hand squeezes the split section together thereby firmly gripping the outer surface of the second tubular member (10). It will be obvious that without limiting the scope of the invention, other quick release locking mechanisms can also be utilized.

It will of course be realized that while the foregoing has been given by way of illustrative example of this disclosure, all such and other modifications and variations thereto as would be apparent to persons skilled in the art are deemed to fall within the broad scope and ambit of this invention as is herein set forth.

Terms used in the following description are to describe specific embodiments and is not intended to limit the disclosure. The expression of singularity includes plurality meaning unless the singularity expression is explicitly different in context. In the specification the terms “comprising” “having,” “including,” and “containing” shall be understood to indicate features, numbers, steps, operations, elements, parts, and/or combinations but not to exclude one or more features, numbers, steps, operations, elements, parts, and/or combinations or additional possibilities. This definition also applies to variations on the terms “comprising” and “containing” such as “comprise”, “comprises”, “have”, “has”, “include”, “includes”, “contain” and “contains”.

While the present invention has been described in connection with certain exemplary embodiments, it will be appreciated by those skilled in the art that various modifications and changes may be made without departing from the scope of the present disclosure. It should be understood that the exemplary embodiments described therein should be considered in a descriptive sense only and not for purposes of limitation. Descriptions of features or aspects within each embodiment should typically be considered as available for other similar features or aspects in other embodiments. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An adjustable bicycle workstand, comprising:
a height adjustable post having at least a first member having a ground engaging portion or support base, and a second tubular member, wherein the second tubular member is insertable into the first tubular member in a telescopic arrangement;
an internally housed mechanism for extension and retraction of the second tubular member from the first tubular member; and
an attachment means for mounting a bicycle on the second tubular member such that the bicycle may be raised and lowered between a first position and a second position whilst remaining attached to the second tubular member.

2. The bicycle workstand of claim 1, wherein the attachment means is rotatably connected to the second tubular member and configured to permit 360 degree rotation of the bicycle.

3. The bicycle workstand of claim 1, wherein the workstand is height adjustable using a mechanical winding means.

4. The bicycle workstand of claim 3, wherein the attachment means is rotatably connected to the second tubular member and configured to permit 360 degree rotation of the bicycle.

5. The bicycle workstand of claim 3, wherein the mechanical winding means is an internally housed rack and pinion arrangement configured to extend and retract the second tubular member from the first tubular member.

6. The bicycle workstand of claim 5, wherein the attachment means is rotatably connected to the second tubular member and configured to permit 360 degree rotation of the bicycle.

7. The bicycle workstand of claim 1 further comprising a quick release lock mechanism configured to lock the first and second tubular members together and prevent rotation of the bicycle attached to the second tubular member.

8. The bicycle workstand of claim 1, wherein the attachment means is a clamp configured to grasp a bicycle frame.

9. The bicycle workstand of claim 1, wherein the attachment means is selected from the group consisting of a fastener, tie, rope, velcro, hook, male-female attachment, screw, and lock.

10. The bicycle workstand of claim 1 further comprising an electric motor drive system configured to adjust the height of the height adjustable post.

11. A method of using the bicycle workstand of claim 1, comprising safely and securely supporting the bicycle during at least one of assembly, maintenance and repair.
